(19) United States
(12) Patent Application Publication
(10) Pub. No.: US 2006/0127041 A1
(43) Pub. Date: Jun. 15, 2006

(54) Recording and reproducing apparatus

(75) Inventor: Yasuhiro Shimizu, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/288,353

(22) Filed: Nov. 29, 2005

(30) Foreign Application Priority Data
Nov. 30, 2004 (JP) 2004-347321

(51) Int. Cl. H04N 7/52

(52) U.S. Cl. 386/95

(57) ABSTRACT

A recording and reproducing apparatus is provided which can easily record and reproduce recorded content information that is displayable irrespective of the type of a reproducing apparatus, which can record and display the recorded content information by detecting it also from data other than EPG data, and which can cope with thumbnail display. A title image 5 is generated with reference to EPG data 3 and other data 4 except for the EPG data, and the generated title image 5 is recorded for a fixed duration of time so that it precedes or follows video/audio data 1 to be recorded. In the title image 5, a title name, date and time of recording, input source, category, recording duration, recording mode, and recording user information are displayed, and the title image 5 can be combined with a background image 8. Functions of generating and displaying thumbnail images can additionally be provided.

The present application is based on and claims priority of Japanese patent application No. 2004-347321 filed on Nov. 30, 2004, the entire contents of which are hereby incorporated by reference.

### BACKGROUND OF THE INVENTION

1. Field of the Invention

The present invention relates to a recording and reproducing apparatus capable of recording video/audio data input from a television and the like onto a recording medium such as a DVD or an optical disk, and also capable of reproducing the video/audio data recorded onto the recording medium, wherein the recording and reproducing apparatus can record title names and other recorded content information associated with the video/audio data recorded onto the recording medium so as to allow a user to know those title names and other information of the video/audio data by displaying the recorded content information.

2. Description of the Related Art

A typical technique for displaying recorded content information is thumbnail display, which is disclosed, for example, in Japanese Patent Laid-Open Publication No. 2003-272358 (patent document 1), “Method for Editing Recorded Information and Recording and Editing Apparatus for Disk Storage Medium”. In this technique, a thumbnail image is extracted and stored in relation to each data recorded onto a recording medium, and a user can reproduce his/her desired data by selecting one of thumbnail images displayed on a thumbnail screen.

Another technique for displaying recorded content information is disclosed, for example, in Japanese Patent Laid-Open Publication No. 2004-120170 (patent document 2), “Receiver and Recording Setting Method”. In this technique, a title screen to be recorded just before a reserved recording is started is created using EPG data, and this title screen is stored as apart of recorded data at the head thereof. Upon reproduction, TV program information (date and time of broadcast, and title name) of a reproduced program is displayed at the beginning of reproduction data. If the EPG data contains the category of the program, this category can be displayed. A plurality of types of backgrounds is prepared for the title screen. These backgrounds are selectable according to recording time or category.

In the above conventional recording and reproducing apparatus using thumbnail images, extra operations are required in addition to usual recording and reproducing operations, which leads to complex and difficult operability, because the recorded content information cannot be displayed until the thumbnail screen is activated by user's intention. Furthermore, the main contents of data cannot be reproduced until a user selects one of thumbnail images displayed on the activated thumbnail screen. Moreover, when a different recording and reproducing apparatus from the one used for recording data is used to reproduce it, or depending on the type of a reproducing apparatus, there is the case where the main contents of this data is reproducible, but the recorded content information cannot be confirmed because the thumbnail screen is not displayable. The recorded content information of a program recorded by a recording and reproducing apparatus from a particular manufacturer occasionally cannot be displayed or supported by a different recording and reproduction apparatus because of a lack of screen display function.

In the other conventional recording and reproducing apparatus that creates a title screen using the EPG data and records this title screen as a part of recorded data at the head thereof, only the data contained in the EPG data is referred as the recorded content information, and therefore recording duration, recording mode, input source, user information, and the like, are not reflected on the recorded content information. That is, information other than the EPG data cannot be added to the title image. The EPG data is for the purpose of information of broadcast programs, and recorded content information on the user side cannot be displayed as the title image. The recorded content information including a recording mode, recording duration, recording user, and the like, is neither recordable nor displayable. Furthermore, a user is forced to view the title screen every time before the video/audio data of the main contents is reproduced, which makes some users irritated at times.

### SUMMARY OF THE INVENTION

The present invention is made in consideration of the foregoing circumstances, and an object thereof is to provide a recording and reproducing apparatus that can easily record and reproduce recorded content information which is displayable irrespective of the type of a reproducing apparatus, that can record not only EPG data but also user-side data other than the EPG data, that can set so that no title image is recorded at the beginning of video/audio data of the main contents, and that can cope with a user's demand requesting a thumbnail display function.

According to the first aspect of the present invention, there is provided a recording and reproducing apparatus that can record video/audio data onto a recording medium in units of data files, and that can reproduce the video/audio data recorded onto the recording medium in units of data files. This recording and reproducing apparatus at least includes: a recording function for recording video/audio data of an input broadcast program onto a recording medium for a given period of time; a title image generating function for generating a title image having therein recorded content information that contains a title name and other information, by referring to EPG data and other data except for the EPG data, the other data including clock information, recorded content information, and user input information; a title image recording function for recording the generated title image so that the title image precedes or follows the video/audio data to be recorded, as a fixed duration of video data according to the same recording method as that for the video/audio data; and a control function for controlling the entire operation, wherein the video/audio data and the title image are recorded as a continuously reproducible data file.

According to a second aspect of the present invention, in the recording and reproducing apparatus of the first aspect of the present invention, a recording start instruction is executed earlier than a setting start time of recording by a length of time for recording the title image, the title image is then generated and recorded onto the recording medium as the fixed duration of video data, and subsequently the video/audio data is recorded to serially follow the title image for the given period of time from the setting start time of recording until a setting end time of recording.

According to a third aspect of the present invention, in the recording and reproducing apparatus of the first aspect of the present invention, the video/audio data is recorded onto the recording medium for the given period of time when a recording start instruction is executed, the title image is generated simultaneously with a recording end instruction, and the generated title image is recorded to serially follow the video/audio data as the fixed duration of video data.

According to a fourth aspect of the present invention, in the recording and reproducing apparatus of the first, the second, or the third aspect of the present invention, the recording start instruction is issued when recording by reservation is carried out or when a user manually starts recording, and the recording end instruction is executed at a setting time in the case of the recording by reservation and is executed when an operation for stopping recording is made or when a setting period of time elapses in the case of the user's manual recording.

According to a fifth aspect of the present invention, in the recording and reproducing apparatus of the first, the second, the third, or the fourth aspect of the present invention, as the recorded content information, at least a title name, date and time of recording, input source, and category are detected by referring to the EPG data, also at least a recording duration, recording mode, and recording user information are detected by referring to the other data except for the EPG data, and the title image having therein the descriptive recorded content information based on the detected information is generated.

According to a sixth aspect of the present invention, the recording and reproducing apparatus of the first or the fifth aspect of the present invention further includes: a background image extracting function for extracting a background image used for a background of the recorded content information by selecting an arbitrary scene from the video/audio data that is being reproduced; a background combining function for reading the recorded title image and combining the read title image with the extracted background image or with a prepared background image thereby to generate a new background-attached title image; and a title image changing function for changing the video data of the recorded title image with video data of the new background-attached title image, wherein in the data file in which is already recorded the title image and video/audio data, the existing title image is changeable with the background-attached title image.

According to a seventh aspect of the present invention, in the recording and reproducing apparatus of the sixth aspect of the present invention, when the background image is extracted, it is possible to select whether the extraction is made at a setting time determined in advance or in response to a manual operation of a user.

According to an eighth aspect of the present invention, in the recording and reproducing apparatus of the sixth or the seventh aspect of the present invention, a first process is a process for recording the data file containing the video/audio data and the title image preceding or following the same onto the recording medium, a second process is a process for combining the existing title image in the data file with the background image extracted from the video/audio data being reproduced or with the prepared background image so as thereby to generate the new background-attached title image, and a third process is a process for reading the existing title image in the data file and changing the read existing title image with the new background-attached title image, and the first to the third processes or the second to the third processes can automatically be executed in a controlled manner.

According to a ninth aspect of the present invention, the recording and reproducing apparatus of the first, the fifth, the sixth, the seventh, or the eighth aspect of the present invention further includes: a thumbnail generating function for generating a thumbnail image by extracting the title image contained in each of the data files within the recording medium, and storing the generated thumbnail image in a recording area different from the data files; and a thumbnail display function for displaying the thumbnail image.

### BRIEF DESCRIPTION OF THE DRAWINGS

FIG. 1 is a flowchart for recording of video/audio data and recording of a title image in a recording and reproducing apparatus of the present invention;

FIG. 2 is a flowchart for processing steps from the start of recording to the end of recording in the recording and reproducing apparatus of the present invention;

FIG. 3 is a flowchart for processing steps from the setting for recording reservation to the end of recording in the case where recording by reservation is made, in the recording and reproducing apparatus of the present invention;

FIG. 4 is a flowchart for processing steps from the start to end of recording in the case where manual recording is made, in the recording and reproducing apparatus of the present invention;

FIG. 5 is a flowchart for recording of a background-attached title image in the recording and reproducing apparatus of the present invention;

FIG. 6 is a diagram showing an example of the title image in the recording and reproducing apparatus of the present invention; and

FIG. 7 is a block diagram showing an example of the recording and reproducing apparatus of the present invention.

### DETAILED DESCRIPTION OF THE PREFERRED EMBODIMENT

The preferred embodiment of a recording and reproducing apparatus according to the present invention will be described below with reference to the accompanying drawings, but the present invention is not limited to this embodiment.

The recording and reproducing apparatus of the present invention at least has a recording function 2 for recording video/audio data 1 onto a recording medium, a title image generating function 6 for generating a title image 5 having descriptive recorded content information detected by referring to EPG data 3 and other data 4 except for the EPG data, a title image recording function 7 for recording the title image 5 as a fixed duration of video data so that the title image 5 precedes or follows the video/audio data 1, and a control function for controlling the entire operation. This recording and reproducing apparatus can additionally have a background image extracting function 9 for using a scene of the video/audio data 1 as a background of the descriptive recorded content information, a background combining function 10 for combining the already recorded title image 5 with a background image 8 extracted from the video/audio data 1 or with a prepared background image 8, and a title image changing function 11. Moreover, this recording and reproducing apparatus can further have a thumbnail generating function for extracting a title image from the data file within the recording medium and recording the extracted title image, and a thumbnail display function. Additional functions other than the above can also be provided.

First, necessary user input information, recorded content information, and the like, are set. The password of a recording user and the like are also input. Furthermore, it is necessary to select whether to record the title image 5 so that it precedes or follows the video/audio data 1. In addition, a determination is made whether to make a recording by reservation or a manual recording. Next, a recording start instruction is executed according to a reservation or manually. The manual recording means the case where recording is started immediately when an REC key provided on the main unit of the recording and reproducing apparatus or provided to a remote controller thereof is pressed during reception of a TV program, and is called one-touch recording. It is different from the recording by reservation in that recording is started manually. The end time of recording started manually can be set automatically.

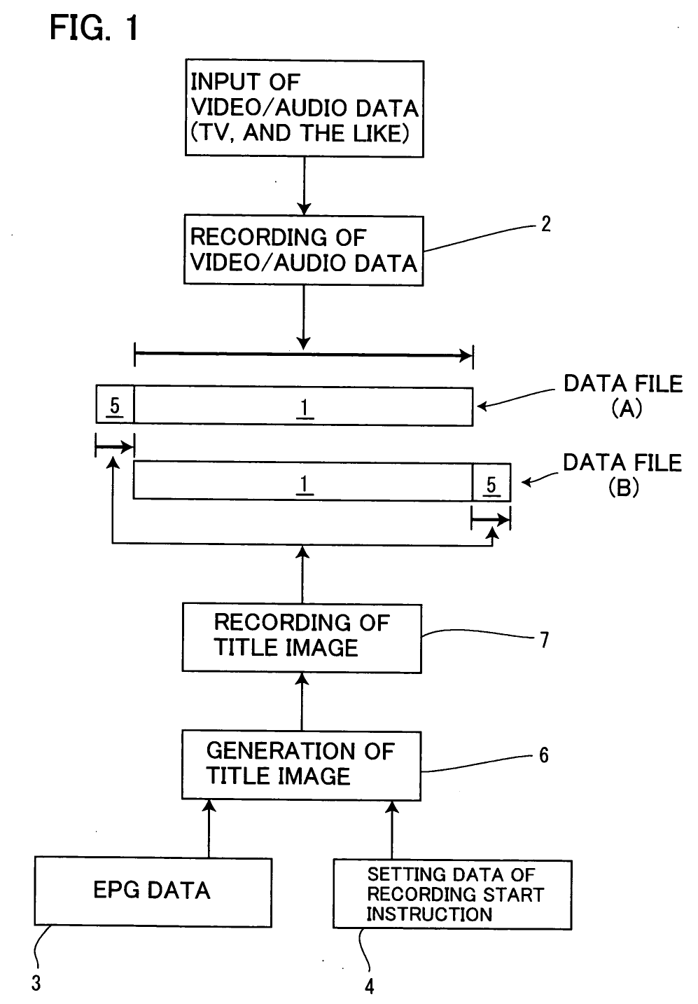

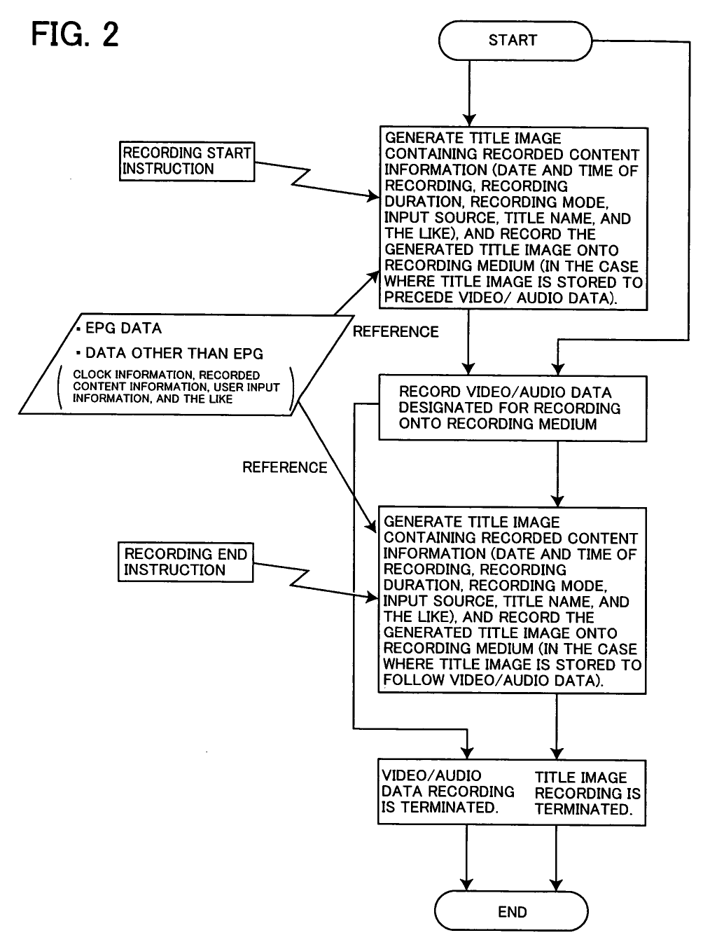

When the title image 5 is recorded so that it precedes the video/audio data 1, various recorded content information is detected by referring to the EPG data 3 and other data 4 except for the EPG data in response to the recording start instruction, and the title image 5 is then generated. The generated title image 5 is recorded at the head of a data file (A) as a set fixed duration of video data, and serially following this video data, the video/audio data 1 is recorded for a set given period of time. Recording is stopped when a recording end instruction is issued at a setting time (see FIGS. 1 and 2). In the case of manual recording, the recording start instruction is issued at the same time when the REC key is pressed, and in the case of recording by reservation, the recording start instruction is executed prior to the setting start time of recording in order to record the title image 5 at the head of the data file (A), and thereafter recording of the video/audio data 1 is started at the setting start time of recording.

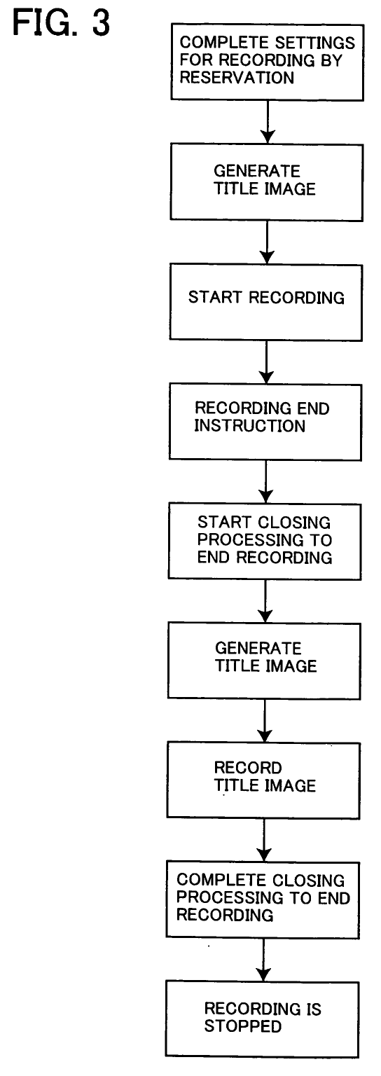

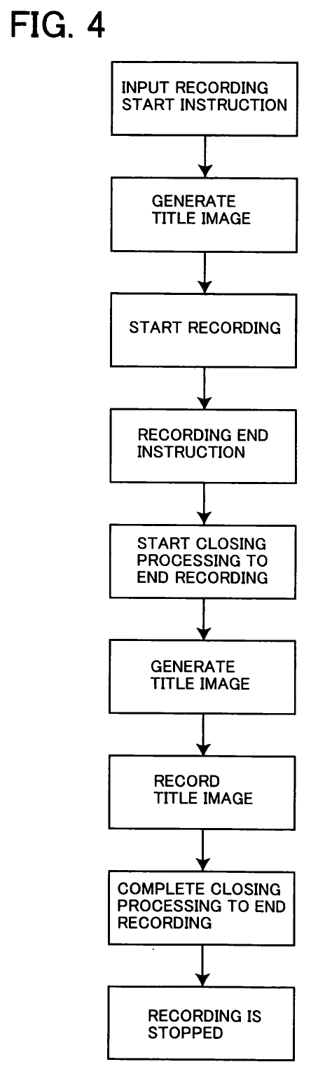

When the title image 5 is recorded so that it follows the video/audio data 1, the video/audio data 1 is recorded at the head of a data file (B) for a set given period of time in response to the recording start instruction. When the recording end instruction is issued at a setting time, closing processing is started in which various recorded content information is detected with reference to the EPG data 3 and other data 4 except for the EPG data so as thereby to generate the title image 5. The generated title image 5 is recorded to serially follow the video/audio data 1 as a set fixed duration of video data. Finally, the closing processing is terminated and the recording is stopped (see FIGS. 1, 2, 3, and 4).

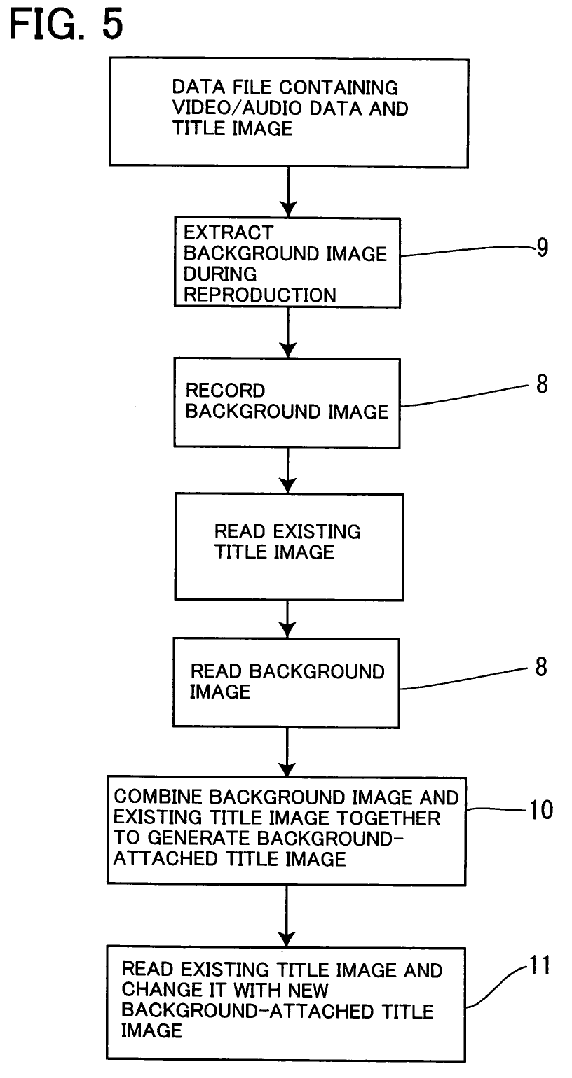

In order to display the background image 8 behind the recorded content information of the data file in which the video/audio data 1 and the title image 5 are already recorded, an image obtained by selecting and extracting a scene of the video/audio data 1, or a prepared image, can be used as the background image 8 for the title image 5 (FIG. 5). Specifically, the recording medium contains the data file in which the title image 5 preceding or following the video/audio data 1 is recorded. The background image 8 is then extracted from the video/audio data 1, which is now being reproduced, by use of the background extracting function 9. Or alternatively, one image is selected from prepared images as the background image 8. Next, the existing title image 5 is read, and it is combined with the background image 8 by use of the background combining function 10 so as thereby to generate a background-attached title image 5. Subsequently, the existing title image 5 recorded in the data file is read to change it with the new background-attached title image 5 by use of the title image changing function 11. The extracted background image 8 is recorded temporally at least until the background-attached title image 5 is generated. A series of processes from the first recording of the video/audio data 1 and the title image 5 until the change of the title image 5, or a series of processes from the reproduction of the video/audio data 1 in the data file until the change of the existing title image 5 with the background-applied title image 5, can be executed automatically in a controlled manner.

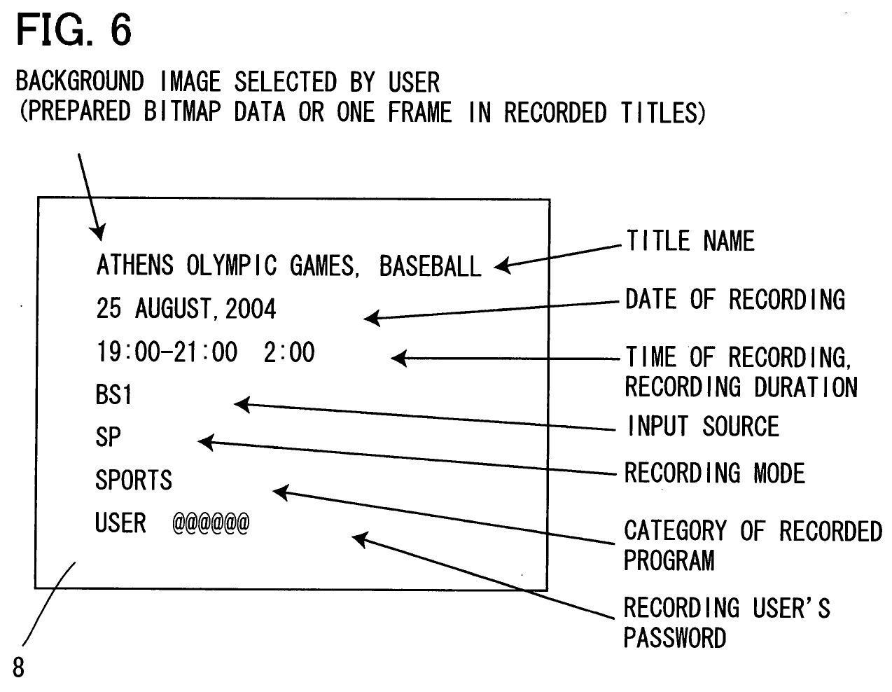

In the title image 5, at least a title name, date and time of recording, recording duration, input source, recording mode, category, and recording user information are displayed, and in the background-applied title image 5, the background 8 is displayed behind the characters of these information (see FIG. 6).

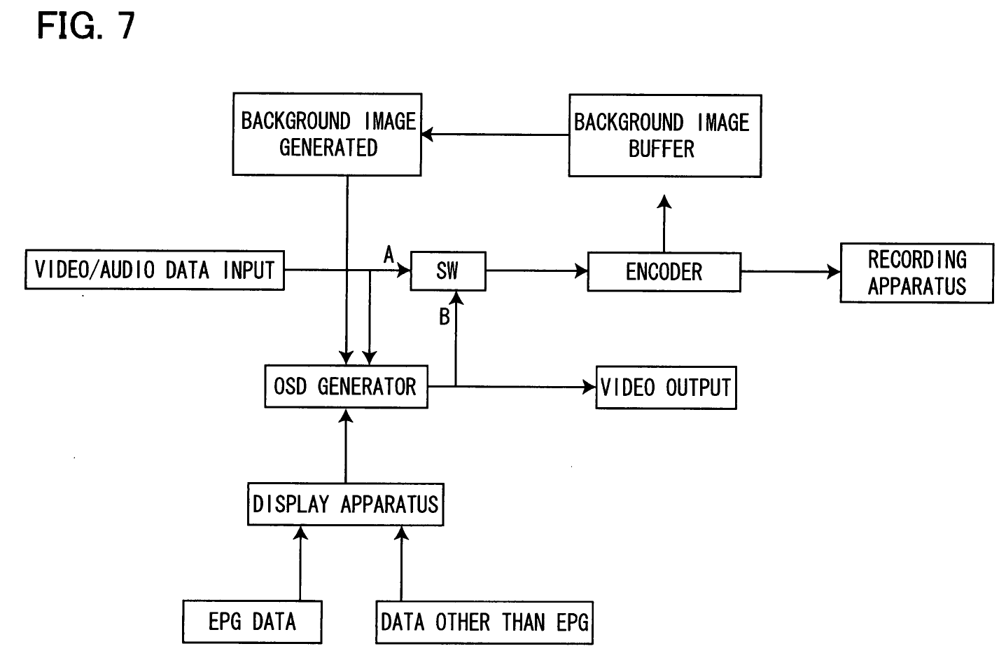

Operation of the recording and reproducing apparatus of the present invention will be described with reference to a block diagram (see FIG. 7). The target video/audio data 1 is input, and it is sent to an SW and an OSD generator. A display controller acquires a title name, date and time of recording, input source, recording mode, recording duration, and recording user information from the EPG data 3 and other data 4 except for the EPG data, and then instructs/controls the OSD generator to generate the title image 5 containing the above recorded content information. The OSD generator sends, to the SW and a video output unit, video signals obtained by superimposing the EPG data 3 and other data 4 except for the EPG data on video signals input from a video input unit in accordance with rendering control instructed by the display controller. The SW selects one of the target video/audio data 1 input from the video input unit and the title image 5 output from the OSD generator, as data to be input to an encoder. This selection is made according to a switching operation so that, when the title image 5 is recorded to follow the video/audio data 1, the target video/audio data 1 is selected when a user presses the REC key in the manual recording, and the title image 5 is selected when the user presses a STOP key. The encoder converts the video/audio data 1 and the title image 5 input from the SW to the MPEG2 format or the like, and sends to the resultant data and image to a recording apparatus. When a background image is extracted, the background image 8 used as a background image 8 for the recorded content information is selected during the conversion process of the encoder, and the selected image is stored in a background image buffer. The processing of selecting an image used as the background image 8 is made according to a user's designation with a key during recording, a designated time determined in advance by a setup menu, or the like. The background image to be combined with the title image 5 is reproduced by inputting the background image 8 stored in the background image buffer to the OSD generator when the title image is generated.

According to the recording and reproducing apparatus of the first aspect of the present invention, the title image containing the recorded content information based on EPG data and other data except for the EPG data can be recorded onto a recording medium so as to precede or follow the video/audio data as one unit of file data. Special operations for recording or displaying the recorded content information are unnecessary at all, and these recording and displaying of the recorded content information can be done by the same operations as usual recording and reproducing operations. The video/audio data of the main contents and the title image indicating the recorded content information are recorded as a series of video images, and therefore only by making a usual reproducing operation, the fixed duration of title image is reproduced and displayed before or after the main contents. When a different recording and reproducing apparatus or a different type of reproducing apparatus is used, the title image containing the recorded content information can be displayed for confirmation, so that data can be shared with other recording and reproducing apparatuses or other reproducing apparatuses.

According to the recording and reproducing apparatus of the second aspect of the present invention, after the fixed duration of title image is recorded, the target video/audio data can be recorded to serially follow this title image. By reproducing the data file according to the usual method, the video/audio data of the main contents can be reproduced continuously after the title image is displayed for the fixed duration.

According to the recording and reproducing apparatus of the third aspect of the present invention, after the target video/audio data is recorded, the fixed duration of title image can be recorded to serially follow this video/audio data. By reproducing the data file according to the usual method, the title image can be displayed continuously after the video/audio data of the main contents is reproduced.

According to the recording and reproducing apparatus of the fourth aspect of the present invention, the video/audio data and the title image can be recorded both in the case of the recording by reservation and in the case of the manual recording.

According to the recording and reproducing apparatus of the fifth aspect of the present invention, as the recorded content information of the title image, at least a title name, date and time of recording, input source, and category which are detected by referring to the EPG data, as well as at least a recording duration, recording mode, and recording user information which are detected by referring to the other data except for the EPG data, can be recorded all together.

According to the recording and reproducing apparatus of the sixth aspect of the present invention, the already recorded title image in the data file can be changed with a new background-attached title image. In addition to confirming the descriptive recorded content information, it is possible to visually recognize recorded contents by using one scene extracted from the video data or a prepared image as a background image. This processing can be executed any time after the recording of the video/audio data and the first recording of the title image are made.

According to the recording and reproducing apparatus of the seventh aspect of the present invention, the background image can be extracted automatically or by a manual operation of a user.

According to the recording and reproducing apparatus of the eighth aspect of the present invention, the first or the second process to the third process can automatically be controlled, where the first process is a process for recording the video/audio data and the title image onto a recording medium as a data file, the second process is a process for combining the existing title image read from the data file with a background image extracted from the video/audio data that is being reproduced or with a prepared background image so as thereby to generate a new background-attached title image, and the third process is a process for changing the existing title image in the data file with the new background-attached title image. All the processes from the first recording process can be executed automatically, and also only the process of changing the existing title image in the data file with a new background-attached title image can be executed automatically. Therefore, only by starting recording with the same operation as that made for recording by reservation or for manual recording, or only by issuing a rewriting instruction to the existing data file, the title image for recorded content information having a background can automatically be recorded to precede or follow the video/audio data, which leads to considerably simple operability.

According to the recording and reproducing apparatus of the ninth aspect of the present invention, the recorded content information can be confirmed not only by displaying the title image recorded as a part of the data file, but also by displaying the thumbnail image. Therefore, without depending on whether the data file is being reproduced or not, a user can recognize the recorded content information in the data file recorded onto the recording medium by displaying the thumbnail images. Even when the thumbnail images cannot be displayed because a different recording and reproducing apparatus or a different reproducing apparatus is used, the recording content information can be confirmed by reproducing the title image recorded in the data file.

1. A recording and reproducing apparatus that can record video/audio data onto a recording medium in units of data files, and that can reproduce the video/audio data recorded onto the recording medium in units of data files, the apparatus at least comprising:
a recording function for recording video/audio data of an input broadcast program onto a recording medium for a given period of time;
a title image generating function for generating a title image having therein recorded content information that contains a title name and other information, by referring to EPG data and other data except for the EPG data, the other data including clock information, recorded content information, and user input information;
a title image recording function for recording the generated title image so that the title image precedes or follows the video/audio data to be recorded, as a fixed duration of video data according to the same recording method as that for the video/audio data; and
a controlling function for controlling the entire operation, wherein
the video/audio data and the title image are recorded as a continuously reproducible data file.

2. The recording and reproducing apparatus according to claim 1, wherein a recording start instruction is executed earlier than a setting start time of recording by a length of time for recording the title image, the title image is then generated and recorded onto the recording medium as the fixed duration of video data, and subsequently the video/audio data is recorded to serially follow the title image for the given period of time from the setting start time of recording until a setting end time of recording.

3. The recording and reproducing apparatus according to claim 1, wherein the video/audio data is recorded onto the recording medium for the given period of time when a recording start instruction is executed, the title image is generated simultaneously with a recording end instruction, and the generated title image is recorded to serially follow the video/audio data as the fixed duration of video data.

4. The recording and reproducing apparatus according to claim 1, 2, or 3, wherein the recording start instruction is issued when recording by reservation is carried out or when a user manually starts recording, and the recording end instruction is executed at a setting time in the case of the recording by reservation, and is executed when an operation for stopping recording is made or when a setting period of time elapses in the case of the user's manual recording.

5. The recording and reproducing apparatus according to claim 4, wherein as the recorded content information, at least a title name, date and time of recording, input source, and category are detected by referring to the EPG data, also at least a recording duration, recording mode, and recording user information are detected by referring to the other data except for the EPG data, and the title image having therein the descriptive recorded content information based on the detected information is generated.

6. The recording and reproducing apparatus according to claim 5, further comprising:
a background image extracting function for extracting a background image used for a background of the recorded content information by selecting an arbitrary scene from the video/audio data that is being reproduced;
a background combining function for reading the recorded title image and combining the read title image with the extracted background image or with a prepared background image thereby to generate a new background-attached title image; and
a title image changing function for changing the video data of the recorded title image with video data of the new background-attached title image, wherein in the data file in which is already recorded the title image and video/audio data, the existing title image is changeable with the background-attached title image.

7. The recording and reproducing apparatus according to claim 6, wherein when the background image is extracted, it is possible to select whether the extraction is made at a setting time determined in advance or in response to a manual operation of a user.

8. The recording and reproducing apparatus according to claim 7, wherein
a first process is a process for recording onto the recording medium, the data file containing the video/audio data and the title image preceding or following the video/audio data, a second process is a process for combining the existing title image in the data file with the background image extracted from the video/audio data being reproduced or with the prepared background image thereby to generate the new background-attached title image, and a third process is a process for reading the existing title image in the data file and changing the read existing title image with the new background-attached title image, and the first to the third processes or the second to the third processes can automatically be executed in a controlled manner.

9. The recording and reproducing apparatus according to claim 8, further comprising:
a thumbnail generating function for generating a thumbnail image by extracting the title image contained in each of the data files within the recording medium, and storing the generated thumbnail image in a recording area different from the data files; and
a thumbnail display function for displaying the thumbnail image.

10. The recording and reproducing apparatus according to claim 1, further comprising:
a background image extracting function for extracting a background image used for a background of the recorded content information by selecting an arbitrary scene from the video/audio data that is being reproduced;
a background combining function for reading the recorded title image and combining the read title image with the extracted background image or with a prepared background image thereby to generate a new background-attached title image; and a title image changing function for changing the video data of the recorded title image with video data of the new background-attached title image, wherein
in the data file in which is already recorded the title image and video/audio data, the existing title image is changeable with the background-attached title image.

11. The recording and reproducing apparatus according to claim 1, further comprising:
a thumbnail generating function for generating a thumbnail image by extracting the title image contained in each of the data files within the recording medium, and storing the generated thumbnail image in a recording area different from the data files; and
a thumbnail display function for displaying the thumbnail image.
